(19) United States
(12) Patent Application Publication
(10) Pub. No.: US 2025/0236042 A1
(43) Pub. Date: Jul. 24, 2025

(54) Multi-Purpose Fuel and Lubricant Auto-Feeding System for Chainsaw Operations

(71) Applicant: Robert Harris, Columbia, KY (US)

(72) Inventor: Robert Harris, Columbia, KY (US)

(21) Appl. No.: 18/418,260

(22) Filed: Jan. 20, 2024

(51) Int. Cl. B27B 17/12; B27B 17/02; F16N 7/02

(52) U.S. Cl. CPC B27B 17/12; F16N 7/02; B27B 17/02

(57) ABSTRACT

A portable fuel and lubricant delivery system for chainsaws is disclosed, comprising a wearable harness and a dual-container assembly. The system is designed to improve the operational efficiency and autonomy of chainsaw use by providing a continuous, automatic supply of fuel and lubricant directly to the chainsaw. One container within the assembly is dedicated to fuel, while the other holds lubricant. The containers are detachable and reconfigurable, accommodating various types and volumes of fuel and lubricants. An integral set of hoses, featuring a gravity feed mechanism, connects the containers to the chainsaw, ensuring a steady flow of fluids. The system further comprises a set of control valves or nozzles for connecting to the chainsaw's intake points, and the hoses are protected by a durable sheath. The invention is adaptable to various chainsaw models and other gas-powered tools, providing a versatile solution for fuel and lubricant delivery in demanding applications.

### BACKGROUND

The present invention relates generally to chainsaw operation and maintenance equipment. More specifically, the invention describes a system that integrates fuel and lubricant storage and delivery for chainsaw applications. The system is designed to enhance the efficiency, safety, and ease of use in various forestry, landscaping, and woodcutting operations.

Chainsaws are essential tools in forestry, agriculture, landscaping, and construction. The efficiency and effectiveness of chainsaw operations depend heavily on continuous and reliable access to fuel and lubricants. Traditional chainsaws, such as the STIHL MS 500i and MS 880 Magnum, incorporate internal tanks for fuel and lubricant storage. While these models exhibit advancements in fuel efficiency and ergonomic design, they require frequent refueling and lubricant replenishment, particularly during extended use or in remote locations.

Portable chainsaws, like the Ridgeyard Gas-Powered Chainsaw and models from Black+Decker and Husqvarna, emphasize compactness and portability, catering to less demanding tasks. However, these models still rely on internal tanks with limited capacity, necessitating regular manual refilling and maintenance, which can disrupt workflow and reduce overall productivity.

Existing solutions in the industry do not fully address the need for a continuous supply of fuel and lubricants during extended chainsaw operation. Operators often need to carry extra fuel and lubricant containers, leading to increased physical burden and operational inefficiency. Furthermore, the lack of an integrated delivery system in current chainsaw models necessitates frequent stops for refueling and maintenance, which can be cumbersome and time-consuming.

Thus, there exists a need for an innovative solution that provides continuous, automatic delivery of fuel and lubricant to chainsaws during operation. Such a solution should ideally be portable, user-friendly, and adaptable to various chainsaw models and user sizes, improving operational efficiency and reducing manual intervention in fuel and lubricant replenishment.

### SUMMARY

In view of the circumstances outlined above, aspects of the present invention disclose a system and method for the implementation of a multi-purpose fuel and lubricant auto-feeding system for chainsaw operations.

The present invention seeks to address the limitations of current chainsaw fuel and lubricant delivery systems by introducing an innovative, portable, and user-friendly solution. This invention significantly enhances the operational efficiency and convenience of using chainsaws for various applications, particularly in situations that demand extended use or involve working in remote locations.

The primary objective of this invention is to provide a portable fuel and lubricant delivery system specifically designed for chainsaws. This system comprises a wearable harness, which ensures ease of carrying and ergonomic weight distribution for the user. Built into the harness is a dual-container assembly, wherein one container is dedicated to holding fuel and the other for lubricant. This dual-container design offers flexibility in carrying different types and volumes of fuel and lubricants, as the containers are detachable and reconfigurable.

A crucial aspect of the invention is the set of hoses that connect the dual containers to the chainsaw. These hoses are designed to facilitate a continuous and uninterrupted flow of fuel and lubricant from the containers to the chainsaw, extending continuous chainsaw operation periods. The system incorporates a gravity feed mechanism, which aids in maintaining this continuous flow, thereby eliminating the need for manual refueling and lubricant replenishment during operation.

The invention further includes an adjustable harness, which can be adapted to fit various user sizes, ensuring comfort and effective weight distribution. This adjustability makes the invention versatile and suitable for a wide range of users. Additionally, the system features a set of valves or nozzles at the end of the hoses, which connect to the chainsaw's fuel and lubricant intake points. These components are designed to control the flow of fuel and lubricant, providing precision and safety in the delivery system.

Another significant feature of the invention is the protective sheath covering the hoses. This sheath is intended to prevent damage and wear to the hoses during operation, thereby enhancing the durability and reliability of the system.

The method of operating a chainsaw using this system involves wearing the harness with the attached fuel and lubricant containers, connecting the hoses to the chainsaw, and then starting and using the chainsaw while the system automatically supplies the necessary fuel and lubricant.

Furthermore, the system includes integrated storage compartments in the harness or containers, which can be used for carrying essential tools such as wrenches and sharpening files. This addition enhances the practicality and utility of the system.

Lastly, the fuel and lubricant delivery system is designed to be compatible with various models of chainsaws and can be adapted for use with other gas-powered tools, making it a versatile and indispensable accessory for a wide range of applications.

In summary, the present invention provides a novel and efficient solution to the challenges faced in conventional chainsaw operation, particularly concerning fuel and lubricant management. Its portability, user-friendliness, and adaptability make it a significant advancement in the field of chainsaw accessories.

### BRIEF DESCRIPTION OF THE DRAWINGS

FIG. 1 depicts a side view of the chainsaw connected to the portable fuel and lubricant delivery system by a set of hoses, demonstrating the system's utility during chainsaw operation.

FIG. 2 depicts a side view of the portable fuel and lubricant delivery system, according to an embodiment of the present invention, illustrating the dual-container assembly attached to a wearable harness.

### DETAILED DESCRIPTION

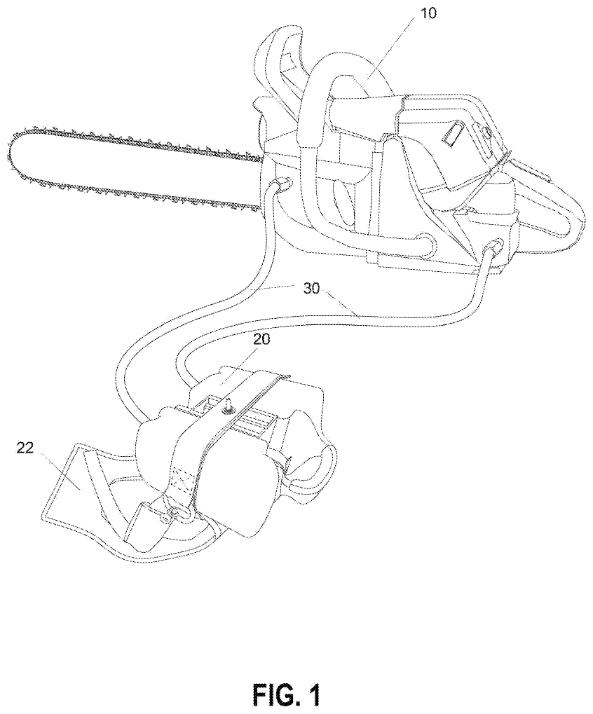

FIG. 1 provides an overview of the dual-container assembly 20, which is removably attached to the wearable harness 22. The harness is configured to be worn by a user and includes means for ergonomic weight distribution and user size adjustability. The dual-container assembly includes a first container for holding fuel and a second container for holding lubricant, such as oil. Each container is equipped with a cap for refilling and a connector for attaching the hoses. The hoses 30 from the gas and oil sides of the dual container assembly feed to the gas and oil tank on the saw 10, respectively.

The system comprises a set of hoses that connect the containers to the chainsaw. The hoses are designed with a gravity feed mechanism to ensure a continuous flow of fuel and lubricant from the containers to the chainsaw without necessitating manual intervention. Additionally, the hoses are encased within a protective sheath to prevent damage and wear from operational use.

The hoses extend from the bottom of each container and are connected to the chainsaw's fuel and lubricant intake points via a set of valves or nozzles, which are designed to control the flow rate to the chainsaw's engine and bar. The chainsaw depicted is of a conventional design, and the system is adaptable to accommodate various models of chainsaws.

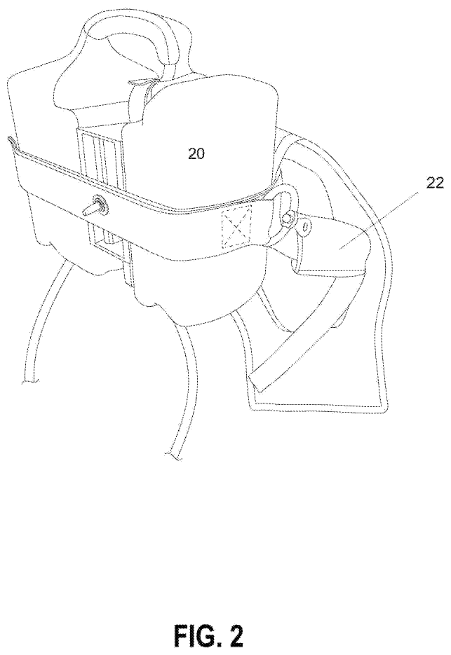

FIG. 2 depicts the dual-container assembly 20 attached to a wearable harness 22.

Additionally, the harness includes adjustable features for user size variability and storage compartments for tools.

The embodiments described above are given for the purpose of facilitating the understanding of the present invention and are not intended to limit the interpretation of the present invention. The respective elements and their arrangements, materials, conditions, shapes, sizes, or the like of the embodiment are not limited to the illustrated examples but may be appropriately changed. Further, the constituents described in the embodiment may be partially replaced or combined together.

What is claimed is:

1. A portable fuel and lubricant delivery system for chainsaws, comprising:
a wearable harness; a dual-container assembly attached to the harness, wherein one container holds fuel and the other container holds lubricant; a set of hoses that connect the containers to a chainsaw; and a gravity feed mechanism that ensures continuous flow of fuel and lubricant from the containers to the chainsaw.

2. The system of claim 1, wherein the containers are detachable and reconfigurable to support different volumes and types of fuel and lubricants.

3. The system of claim 1, wherein the harness is adjustable to fit various user sizes and designed for ergonomic weight distribution.

4. The system of claim 1, further comprising a set of valves or nozzles at the end of the hoses that connect to the chainsaw's fuel and lubricant intake points to control the flow of fuel and lubricant.

5. The system of claim 1, wherein the hoses are covered with a protective sheath to prevent damage and wear during operation.

6. A chainsaw operation method comprising:
wearing a harness with attached containers of fuel and lubricant; connecting the hoses from the containers to the chainsaw; starting the chainsaw, and using the chainsaw while the system automatically supplies fuel and lubricant to it.

7. The system of claim 1, further comprising storage compartments integrated into the harness or containers for carrying tools such as a wrench and a sharpening file.

8. The system of claim 1, wherein the fuel and lubricant delivery system is compatible with various models of chainsaws and can be adapted for use with other gas-powered tools.

9. The system of claim 1, further comprising a pressurization mechanism integrated within the dual-container assembly, wherein the pressurization mechanism is configured to maintain a consistent pressure within the containers to facilitate the upward flow of fuel and lubricant against gravity if the chainsaw is operated in an overhead position.
